(19) United States
(12) Patent Application Publication
(10) Pub. No.: US 2003/0095757 A1
(43) Pub. Date: May 22, 2003

(54) Optoelectronic assembly

(75) Inventors: Michael Burmeister, Minden (DE); Karl Gerdom, Lubbecke (DE); Frank-Ulrich Hartmann, Bunde (DE)

Correspondence Address: Norma P. Soloway, HAYES SOLOWAY P.C., 130 W. Cushing Street, Tucson, AZ, 85701, US

(73) Assignee: HARTING Electro-Optics GmbH & Co. KG

(21) Appl. No.: 10/300,180

(22) Filed: Nov. 20, 2002

(30) Foreign Application Priority Data
Nov. 22, 2001 (DE) 101 57 201.8

(51) Int. Cl. G02B 6/42

(52) U.S. Cl. 385/88

(57) ABSTRACT

An optoelectronic assembly comprises a carrier, an optoelectronic component mounted to the carrier, and at least one guide for an optical waveguide plug able to be coupled with the assembly. A heat sink is provided which is in highly thermoconducting connection with the optoelectronic component, the guide being formed on the heat sink.

### TECHNICAL FIELD

The invention relates to an optoelectronic assembly.

### BACKGROUND OF THE INVENTION

A conventional optoelectronic assembly usually comprises a carrier, an optoelectronic component mounted to the carrier, and at least one guide for an optical waveguide plug able to be coupled with the assembly. Such an assembly is known from published PET document WO 94/28448. Two bores are provided here either directly in the optoelectronic component or else in the carrier for the optoelectronic component and are used as guides. The guide bores serve for receiving guide pins of an optical waveguide plug, for instance a MT plug, the optical waveguides of which are to be coupled with the active surface areas of the optoelectronic component.

In order to obtain a low attenuation loss for the coupling between the optical waveguide plug and the optoelectronic component it is important to have the optical waveguide plug precisely positioned relative to the optoelectronic component. In case the guide bores for the optical waveguide plug are directly provided on the optoelectronic component, a very high accuracy will be achieved. The comparably high expenditure is of advantage, however. On the one hand the optoelectronic component which usually is a semiconductor chip has to be realized with dimensions which offer enough space for making the guide bores. Moreover, the semiconductor chip has to have a sufficient mechanical resistance to be able to take up the forces occurring during insertion of the optical waveguide plug. In case the guide bores are configured in the carrier of the optoelectronic component, very great demands must be made on the mechanical strength of the material for the carrier, because the guide bores—even by repeated inserting and removing of the optical waveguide plug—must not wear out to such an extent that there is a clearance between the guide bores and the guide pins; otherwise an excessively high attenuation loss will occur.

It is the object of the invention to further develop an assembly of the type initially mentioned to the effect that there is no need to observe excessively high demands on selecting the material for the carrier.

### BRIEF SUMMARY OF THE INVENTION

According to the invention, an optoelectronic assembly comprises a carrier, an optoelectronic component mounted to the carrier, and at least one guide for an optical waveguide plug able to be coupled with the assembly. A heat sink is provided which is in highly thermoconducting connection with the optoelectronic component, the guide being formed on the heat sink. The heat sink which in view of high thermal conductivity usually is made of metal, offers best conditions for the construction of a precise and wear resisting guide, in particular for a guide bore. Such a guide bore can be realized with low expenditure as a locating bore into which a guide pin of an optical waveguide plug can be inserted so as to have no play. Due to the fact that the guide is formed on the heat sink, there is no need at all to take into consideration whether the material is suitable for the guide of the optical waveguide plug, when the carrier for the optoelectronic component is selected. Hence, in particular a flexible conductor foil may be used as the carrier, which foil owing to its elasticity would not be suitable to precisely guide the guide pins of the optical waveguide plug.

According to a preferred embodiment it is provided for that the active surface area of the optoelectronic component faces the carrier. In this arrangement, the carrier preferably is a flexible conductor foil or a circuit board, so that the optoelectronic component can be mounted by means of flip chip technology. For this reason the entire rear face of the optoelectronic component will be available for being connected with the heat sink, so that a good carrying-off of heat is ensured. At the same time there is provided a good electrical RF shield of the optoelectronic component and its contact areas by it being arranged between the circuit board (or the conductor foil) and the heat sink.

If the active surface area of the optoelectronic component faces the carrier, then the carrier may be realized so as to be optically transparent. It is preferred, however, that at least one cut-out is provided in the carrier opposite the active surface area, the cut-out being potted with an optically transparent material. In this way the optoelectronic component has a mechanical protection against external influences. In case the optoelectronic component has several active surface areas, one shared cut-out may be provided for all active surface areas. It is preferred, however, that an individual cut-out is provided for each of the active surface areas, so that an optical cross coupling will be prevented between neighboring active surface areas, i.e. the optical channels.

According to a preferred embodiment of the invention a cooling element is provided, the heat sink being a highly thermoconducting intermediate plate of metal with a coefficient of thermal expansion which is approximately equal to that of the optoelectronic component. In this embodiment the heat sink has a dual function. On the one hand it reduces temperature-induced mechanical stresses between the optoelectronic component and the heat sink, because the coefficient of thermal expansion of the intermediate plate is adapted to that of the optoelectronic component. On the other hand the heat sink serves for guiding the guide pin of the optical waveguide plug. According to another preferred embodiment it may be provided for that the heat sink is a cooling element and that an intermediate plate of metal is arranged between the cooling element and the optoelectronic component, the coefficient of thermal expansion of the intermediate plate being approximately equal to that of the optoelectronic component.

It is preferably provided for that the intermediate plate is provided with positioning arrangements which engage in corresponding positioning arrangements of the cooling element. By this means it is guaranteed that cooling element and intermediate plate are passively arranged relative to each other with very high accuracy.

According to a preferred embodiment of the invention it is provided for that the carrier has a recess with a depth which is approximately equal to the thickness of the optoelectronic component, the optoelectronic component being arranged in the recess. A particularly compact construction will be achieved in this way. Moreover, a high mechanical stability is produced, because the heat sink connected with the optoelectronic component can rest on the carrier across an area.

Advantageous designs of the invention will be apparent from the subclaims.

### BRIEF DESCRIPTION OF THE DRAWINGS

FIG. 1 shows in a schematic sectional view an optoelectronic assembly according to a first embodiment of the invention, with an optical waveguide plug inserted;

FIG. 2 shows in a schematic, broken view a section taken along plane II-II of FIG. 1; and

FIG. 3 shows in a schematic sectional view an optoelectronic assembly according to a second embodiment of the invention, with an optical waveguide plug inserted.

### DETAILED DESCRIPTION OF THE PREFERRED EMBODIMENTS

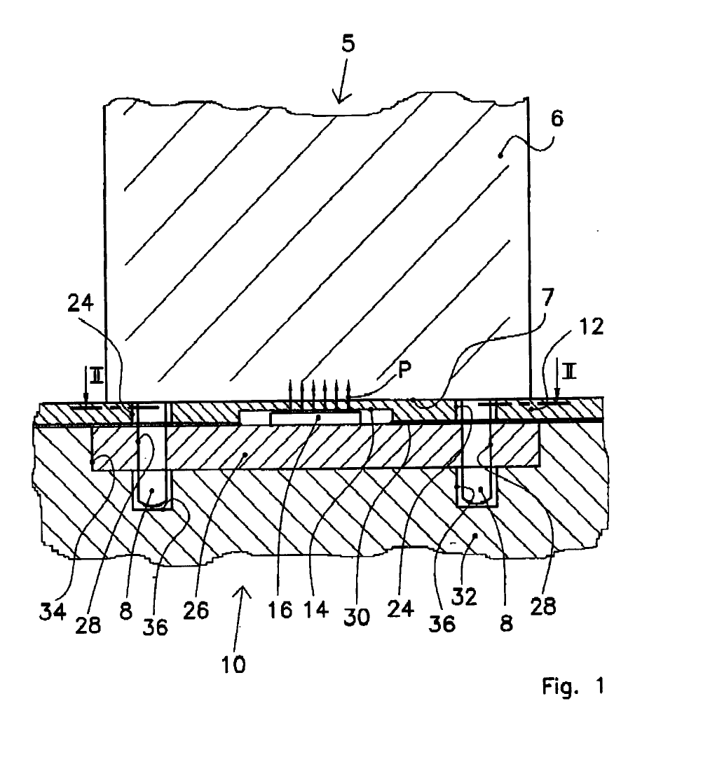

In FIG. 1 there is shown an optoelectronic assembly 10 with an optical waveguide plug 5 being inserted into it. The optical waveguide plug 5 has a housing 6 with several (not illustrated) optical waveguides being arranged therein such that their end faces are exposed on a front face 7 of the housing. Two guide pins 8 project from the front face 7 of the housing 6, which are precisely positioned with respect to the end faces of the optical waveguides. One example of such an optical waveguide plug 5 is a so-called MT plug.

The optoelectronic assembly 10 comprises a carrier 12 which may be a circuit board or a flexible conductor foil. The carrier 12 is provided with a recess 14 in which an optoelectronic component 16 is arranged. The optoelectronic component is preferably a semiconductor chip which has several photosensitive elements (photodetectors) and several light-emitting elements (in particular surface-emitting lasers, VCSEL) formed on it. The optoelectronic component is installed on the carrier 12 by flip chip mounting such that its active surface areas (here symbolized by arrows P) face the carrier 12 and its connecting surfaces are conductively connected with the conductor tracks of the circuit board or of the flexible conductor foil.

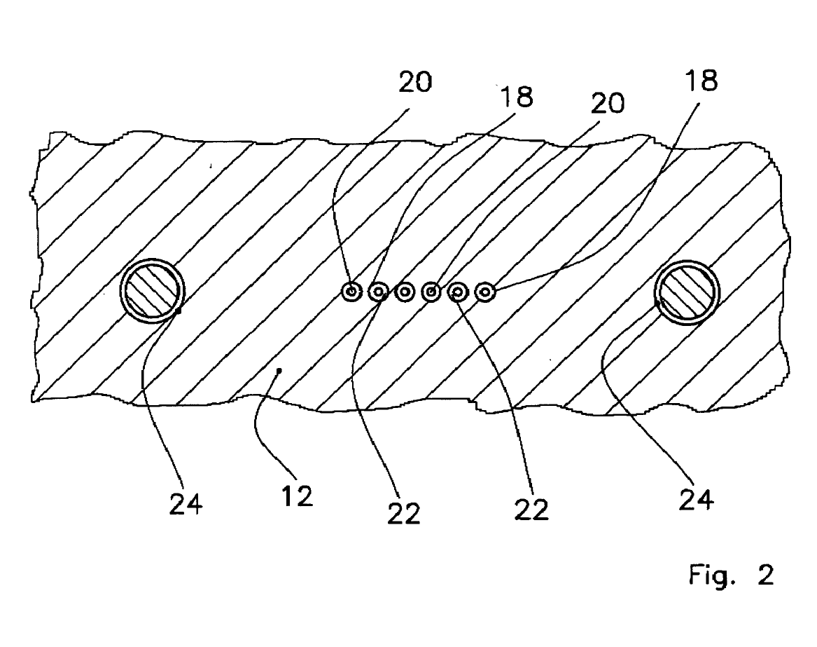

The carrier 12 is provided with several circular cut-outs 18 (see FIG. 2) which each are associated with an active surface area 20 of the optoelectronic component 16. Each cut-out 18 is potted with an optically transparent scaling compound 22, so that the optoelectronic component 16 is mechanically protected from contamination and damage. Finally, formed in the carrier 12 are two openings 24 the function of which will be explained below. The diameter of the openings 24 is larger than the diameter of the guide pins 8 of the optical waveguide plug 5.

On the rear face of the optoelectronic component 16 facing away from the active surface areas 20 there is arranged an intermediate plate 26 which acts as a heat sink, this plate being in highly thermoconducting connection with the optoelectronic component 16. To this end, the intermediate plate 16 may be connected with the optoelectronic component 16 by means of soldering or gluing. The intermediate plate 26 is made of a material the coefficient of thermal expansion of which is adapted to that of the optoelectronic component 16, for example silicone carbide or a copper-tungsten alloy. The intermediate plate 26 is provided with guides in the form of guide bores 28 able to receive the guide pins 8 of the optical waveguide plug 5. The mutual distance between the guide bores 28 corresponds exactly to that between the guide pins 8.

As the optoelectronic component 16 is arranged in the recess 14 of the carrier 12, the intermediate plate 26 may be connected with the carrier 12 across an area, for instance by a layer 30 of gluing agent. In this way a high mechanical strength is produced.

On the rear face of the intermediate plate 26 facing away from the optoelectronic component 16 there is arranged a cooling element 32 which is in highly thermoconducting connection with the intermediate plate 26. In the embodiment shown, the cooling element 32 is provided with an accommodation space 34 for the intermediate plate 26, so that the latter is received with s snug fit. As an alternative it is likewise possible to provide e.g. centrally arranged positioning arrangements on intermediate plate 26 and cooling element 32 which engage into each other, while a gap is provided to the side of the intermediate plate. It is in this way that stresses can be reduced which come from differing thermal expansion of the cooling element and the intermediate plate. The cooling element 32 is provided with recesses 36 which are arranged behind the guide bores 28 of the intermediate plate 26. The diameter of the recesses 36 is larger than the diameter of the guide pins 8 of the optical waveguide plug.

The optoelectronic assembly 10 is mounted in the following way: First, the guide bores 28 are formed in the intermediate plate 26. This may be done by stamping. If a MT plug is to be fitted to the optoelectronic assembly, a tolerance range has to be observed which is ±1 μm for the diameter of the guide bores and ±3 μm for the mutual distance of the guide bores. After having manufactured the guide bores, the optoelectronic component 16 is arranged on the intermediate plate 26 such that the optically active surface areas of the optoelectronic component are arranged precisely relative to the guide bores 28. Here too, a tolerance range of ±1 μm should be observed. Active optical systems are particularly suitable for positioning the optoelectronic component 16. When the optoelectronic component is precisely positioned, it is connected with the intermediate plate 26 by means of soldering.

The subassembly produced in this way is arranged on the carrier 12 which beforehand has been provided with the recesses 18 and the openings 24. The tolerances that are to be observed during arranging the sub-assembly—constituted by the optoelectronic component 16 and the intermediate plate 26—on the carrier 12 are essentially determined in that the electrical contact areas of the optoelectronic component 16 have to be correctly associated to the bond pads of the carrier 12. Again active optical system may be employed for the mutual alignment. When the subassembly is aligned relative to the carrier 12, the optoelectronic component 16 is soldered with the bond pads of the carrier 12 in flip chip technology. Further, the intermediate plate 26 is connected with the carrier 12 by means of gluing. As a next step, the recesses 18 are potted such that the optically active surface areas 20 of the optoelectronic component 16 are protected. Finally, the cooling element 32 is mounted.

Upon inserting an optical waveguide plug 5 into the optoelectronic assembly 10 the guide pins 8 of the optical waveguide plug 5 are inserted right through the openings 24 of the carrier 12 into the guide bores 28 of the intermediate plate 26. The openings 24 merely serve to assist insertion, because the diameter of the openings 24 is larger than that of the guide pins 8. The cooling element 32 has no guiding function either, because the recesses 36 have a larger diameter than the guide pins 8.

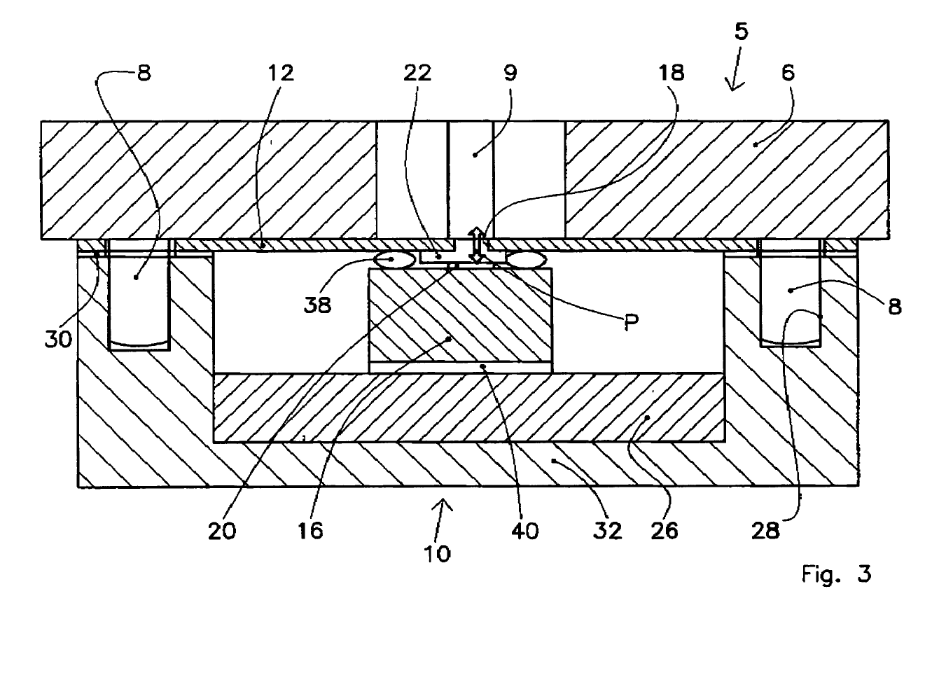

In FIG. 3 there is shown an optoelectronic assembly 10 according to a second embodiment. The same reference numerals are used for elements known from the first embodiment and reference is made to the explanations above.

In FIG. 3 the dimensions of the optoelectronic component are extremely enlarged as compared with the other components. So the active surface area 20 can be seen well which is coupled with an optical waveguide 9 of the optical waveguide plug 5 by means of the sealing compound 22 and right through the cut-outs 18. Soldering beads 38 are also to be seen, which serve for joining connecting surfaces of the optoelectronic component 16 with associated bond pads formed on the conductor foil which is used as carrier 12. Finally, a solder layer 40 is to be seen by means of which the optoelectronic component 16 is connected with the intermediate plate 26.

The most appreciable difference between the first and second embodiments is that the guide bores 28, which serve for guiding the guide pins 8 of the optical waveguide plug 5, are not formed in the intermediate plate 26, but in the cooling element 32.

1. An optoelectronic assembly comprising a carrier, an optoelectronic component mounted to said carrier, and at least one guide for an optical waveguide plug able to be coupled with said assembly, the improvement comprising a heat sink which is in highly thermoconducting connection with said optoelectronic component, said guide being formed on said heat sink.

2. The optoelectronic assembly according to claim 1, wherein said guide is a locating bore, a guide pin being provided on said optical waveguide plug and adapted to be inserted in said locating bore.

3. The optoelectronic assembly according to claim 1, wherein said optoelectronic component has an active surface area facing said carrier.

4. The optoelectronic assembly according to claim 3, wherein at least one cut-out is provided in said carrier opposite said active surface area, said cut-out being potted with an optically transparent material.

5. The optoelectronic assembly according to claim 4, wherein said optoelectronic component has several active surface areas and an individual cut-out is provided for each of said active surface areas.

6. The optoelectronic assembly according to claim 4, wherein said optoelectronic component has several active surface areas and one shared cut-out is provided for all active surface areas.

7. The optoelectronic assembly according to claim 1, wherein a cooling element is provided and wherein said heat sink is a highly thermoconducting intermediate plate of metal with a coefficient of thermal expansion which is approximately equal to that of said optoelectronic component.

8. The optoelectronic assembly according to claim 1, wherein said heat sink is a cooling element and an intermediate plate of metal is arranged between said cooling element and said optoelectronic component, the coefficient of thermal expansion of said intermediate plate being approximately equal to that of said optoelectronic component.

9. The optoelectronic assembly according to claim 7, wherein said intermediate plate is provided with positioning arrangements which engage in corresponding positioning arrangements of said cooling element.

10. The optoelectronic assembly according to claim 8, wherein said intermediate plate is provided with positioning arrangements which engage in corresponding positioning arrangements of said cooling element.

11. The optoelectronic assembly according to claim 1, wherein said carrier is a flexible conductor foil having bond pads which are connected with connecting surfaces of said optoelectronic component by soldering.

12. The optoelectronic assembly according to claim 11, wherein said flexible conductor foil is provided with an opening having a diameter which is larger than a diameter of said locating bore.

13. The optoelectronic assembly according to claim 12, wherein said flexible conductor foil together with said heat sink forms an RF shield for said optoelectronic component.

14. The optoelectronic assembly according to claim 1, wherein said carrier has a recess with a depth which is approximately equal to a thickness of said optoelectronic component, said optoelectronic component being arranged in said recess.
